(19) United States
(12) Patent Application Publication
(10) Pub. No.: US 2025/0157448 A1
(43) Pub. Date: May 15, 2025

(54) BROADBAND SOUND ABSORPTION DEVICE USING AREA DIVISION

(71) Applicant: KOREA ADVANCED INSTITUTE OF SCIENCE AND TECHNOLOGY, Daejeon (KR)

(72) Inventors: Wonju JEON, Daejeon (KR); Hyeonbin RYOO, Daejeon (KR); Jiwan KIM, Daejeon (KR)

(21) Appl. No.: 18/725,583

(22) PCT Filed: Nov. 30, 2022
(86) PCT No.: PCT/KR2022/019233

§ 371 Date: Jun. 28, 2024

(30) Foreign Application Priority Data
Dec. 29, 2021 (KR) 10-2021-0190937

(51) Int. Cl. G10K 11/172

(52) U.S. Cl. CPC G10K 11/172; G10K 2210/3214; G10K 2210/32272; G10K 2210/512

(57) ABSTRACT

The present invention relates to a broadband sound absorption device using area division, the device comprising: Helmholtz resonators including a neck portion and a cavity portion connected to the neck portion and having a predetermined area and thickness; and a unit sound absorber including at least one pair of the Helmholtz resonators, wherein a plurality of unit absorbers are arranged on a plane or curved surface, and the plurality of sound unit absorbers are formed to have cavity portions with different areas to minimize the thickness while enabling sound absorption for a wider band.

### TECHNICAL FIELD

The present invention relates to a broadband sound absorption device using area division, and more particularly, to a broadband sound absorption device configured to absorb sound at multiple frequencies using a Helmholtz resonator and exhibit a high sound absorption rate in a wide frequency range of 1000 Hz or lower.

### BACKGROUND ART

A device that efficiently reduces ambient noise is an important matter to be considered in everyday life or industrial sites. Sound absorption methods used in many industrial sites to reduce noise occurring from various mechanical equipment, etc. may be typically divided into porous, resonance, and plate-type sound absorption methods depending on their principles. Here, the porous-type sound absorption method improves the sound absorption rate at specific frequencies and broadband frequencies by adopting appropriate materials having high sound absorption performance, and the resonance-type and plate-type sound absorption method partially improves the sound absorption rate at specific frequencies by modifying an internal shape of a sound absorbing structure. Here, the resonance-type sound absorption method often uses Helmholtz resonators, and a resonance frequency f of a typical Helmholtz resonator is determined according to Equation 1 below.

$$f = \frac{{υ}_{s}}{2 π} \sqrt{\frac{S}{Vl}} \qquad [ Equation 1 ]$$

Here,
vₛ: speed of sound,
S: area of neck portion,
V: volume of cavity portion, and
l: length of neck portion)

Currently known sound absorption devices are configured to include a plurality of Helmholtz resonators having different resonance frequencies to reduce noise in multiple frequency bands. Here, the Helmholtz resonator is generally formed to have a large cavity portion volume in order to absorb lower frequency sounds.

Referring to FIG. 1, the sound absorption device 1 of FIG. 1 is a technology in which a plurality of Helmholtz resonators having different resonance frequencies but the same cross-sectional area are disposed, and a thickness Lₜₒₜₐₗ of the entire device is determined by a thickness Lₘₐₓ of the Helmholtz resonator that absorbs the lowest frequency among a plurality of Helmholtz resonators. In this case, there was a limitation in that it was difficult to minimize the thickness of the entire device, in addition to the fact that unnecessary space was created, compared to the fact that a Helmholtz resonator that absorbs higher frequencies requires only a relatively small thickness.

Referring to FIG. 2, a sound absorption device 2 of FIG. 2 relates to technology of securing volume by bending a cavity portion 2b in order to arrange a plurality of Helmholtz resonators having different resonance frequencies but having the same cross-sectional area. Here, the sound absorption device 2 of FIG. 2 advantageously has a lower overall device thickness Lₜₒₜₐₗ compared to the sound absorption device 1 of FIG. 1, but it is difficult to use in practice due to the disadvantage of increased manufacturing complexity.

### RELATED ART DOCUMENT

### Patent Document

KR 10-2116466 B1 (published on May 28, 2020)

### DISCLOSURE

### Technical Problem

An object of the present invention is to provide a broadband sound absorption device using area division capable of adjusting a resonance frequency of each Helmholtz resonator by changing any one of components constituting an area of a cavity portion. Through this, the present invention may be applied to solve noise problems in fields in which it is necessary to selectively absorb multiple-frequency noises or broadband noises with a thickness smaller than the related art. More specifically, fields that require selective absorption of multiple-frequency noises include large home appliances, such as clothes dryers and dishwashers, and power generation and electricity fields, such as transformers, and fields that require broadband noise absorption include a field of transportation means, such as vehicles and drones, urban air mobility (UAM), and a mobile device field, such as smartphones and tablets.

The problems of the present invention are not limited to the problems mentioned above, and other problems not mentioned will be clearly understood by those skilled in the art from the description below.

### Technical Solution

In one general aspect, a broadband sound absorption device includes: a Helmholtz resonator including a neck portion and a cavity portion connected to the neck portion and having a predetermined area and thickness; and a unit sound absorber including at least a pair of the Helmholtz resonators, wherein the unit sound absorbers are provided in plurality and arranged on a plane or curved surface, and the plurality of unit sound absorbers include Helmholtz resonators having cavity portions with different areas, respectively.

In addition, the unit sound absorber may include at least a pair of Helmholtz resonators that satisfies an equation below:

f₁≤f_{T}≤f₂

(Here,
f₁: a resonance frequency of one Helmholtz resonator,
f₂: a resonance frequency of another Helmholtz resonator, and
f_{T}: a target frequency)

In addition, in the Helmholtz resonator of each of the plurality of unit sound absorbers, any one of a width and a length forming the area of the cavity portion may be different to have a different target frequency.

In addition, in the Helmholtz resonator of each of the plurality of unit sound absorbers, a cross-section of the cavity portion may be polygonal or circular.

In addition, some of the plurality of unit sound absorbers may each include Helmholtz resonators having the same horizontal length and different vertical lengths, and some of the unit sound absorbers may be arranged in a vertical direction.

In addition, some of the plurality of unit sound absorbers may each include Helmholtz resonators having different horizontal lengths and the same vertical length, and some of the unit sound absorbers may be arranged in a horizontal direction.

In addition, a plurality of the unit sound absorbers may form a polygonal or circular sound absorbing surface.

In addition, the other unit sound absorbers of the plurality of unit sound absorbers may have an arrangement in a different direction from some of the unit sound absorbers.

In addition, in the Helmholtz resonator of each of the plurality of unit sound

absorbers, a minimum value x_{i,min} of a variable component forming the area of the cavity portion may be calculated by an equation below:

x_{i,min}=f(λᵢ,y,c,l)=mλᵢⁿ

(here,

$$A = x \times y ,$$

λᵢ: a target wavelength,
A: an area of the cavity portion,
y: a length of a fixed component of area of cavity portion,
c: a thickness of the cavity portion,
l: a length of the neck portion, and
m, n=constant)

In addition, in the Helmholtz resonator of each of the plurality of unit sound absorbers, the minimum value x_{i,min} of the variable component forming the area of the cavity portion may be calculated by an equation below:

$${x}_{i , min} = m {λ}_{i}^{n} = ( {m}_{1} y + {m}_{2} c + {m}_{3} l + {m}_{4} ) {λ}_{i}^{n}$$

(here, m₁, m₂, m₃, m₄=constant)

In addition, the constants m₁, m₂, m₃, m₄ and n may be formed within the range below
−3<m₁<−1
−2<m₂<−1
−2<m₃<0
130<m₄<190
1.6<n<1.7

In addition, a total length (D) in a direction of a variable component and a sum

$$( {\sum }_{i}^{N} {x}_{i} )$$

of variable components of the Helmholtz resonators of each of the unit sound absorbers arranged may be formed by a relational expression below.

$${\sum }_{i}^{N} {x}_{i} = D - ( N + 1 ) t$$

(here,
N=a total number of disposed Helmholtz resonators, and
t: a thickness of a partition of unit sound absorber)

In addition, in the plurality of unit sound absorbers, a predetermined frequency band having a sound absorption rate of 90% or more forms a sound absorption rate band, and FOM calculated by an equation below may be 3 or more.

$$FOM = [ {α}_{90 avg} ] \times [ \frac{Δ {f}_{90}}{{f}_{90 c}} ] \times [ \frac{{λ}_{90 max}}{\sqrt[3]{V}} ]$$

(here,
α_{90avg}: an average sound absorption rate in a sound absorption rate band of 90% or more,
Δf₉₀: a width of a sound absorption rate band of 90% or more,
f_{90c}: a center frequency of the sound absorption rate band of 90% or more,
λ₉₀ₘₐₓ: a longest wavelength in the sound absorption rate band of 90% or more, and
V: a volume of cavity portion)

### Advantageous Effects

The broadband sound absorption device according to the present invention having the aforementioned configuration has the advantage of simultaneously absorbing noise of a plurality of frequency components and enabling more efficient space utilization. In particular, the broadband sound absorption device according to the present invention has the advantage of broadening utilization by reducing noise occurring in a wider range of industries, such as home appliances, power generation and electrical equipment, transportation means, and mobile devices.

In addition, the broadband sound absorption device according to the present invention has the advantage of enabling sound absorption in a wide frequency band and maintaining sound absorption performance even when an angle of incidence of noise changes, and thus, the broadband sound absorption device may be used in various industrial fields. In particular, the broadband sound absorption device according to the present invention has the advantage of maintaining high efficiency sound absorption performance even when the angle of incidence of sound is tilted to around 60° and being configured by utilizing various materials, such as metal, glass, plastic, wood, and rubber, rather than a specific material, which may lead to the advantage of easier manufacturing.

### BRIEF DESCRIPTION OF THE DRAWINGS

FIGS. 1 and 2 are cutaway views illustrating a sound absorption device according to the related art.

FIG. 3 is a perspective view of a broadband sound absorption device according to a first exemplary embodiment of the present invention.

FIG. 4 is a cutaway view illustrating a configuration of a Helmholtz resonator according to the first exemplary embodiment of the present invention.

FIG. 5 is a front view of a broadband sound absorption device according to the first exemplary embodiment of the present invention.

FIG. 6 is a front view of a unit sound absorber according to the first exemplary embodiment of the present invention.

FIG. 7 is a diagram showing comparison between the broadband sound absorption device according to the first exemplary embodiment of the present invention and the sound absorption device of the related art.

FIGS. 8 and 9 are diagrams illustrating a process of calculating a minimum value of a variable component of a cavity portion of the broadband sound absorption device according to the first exemplary embodiment of the present invention.

FIGS. 10 to 12 are diagrams illustrating sound absorption performance based on a combination of various target frequencies according to the first exemplary embodiment of the present invention.

FIG. 13 is a front view of a broadband sound absorption device according to a second exemplary embodiment of the present invention.

FIG. 14 is a diagram illustrating sound absorption performance based on a combination of target frequencies according to the second exemplary embodiment of the present invention.

FIG. 15 is a diagram illustrating sound absorption performance according to an angle of incidence of sound according to the second exemplary embodiment of the present invention.

FIG. 16 is a front view of a broadband sound absorption device according to a third exemplary embodiment of the present invention.

FIG. 17 is a diagram illustrating sound absorption performance based on a combination of target frequencies according to the third exemplary embodiment of the present invention.

FIG. 18 is a front view of a broadband sound absorption device according to a fourth exemplary embodiment of the present invention.

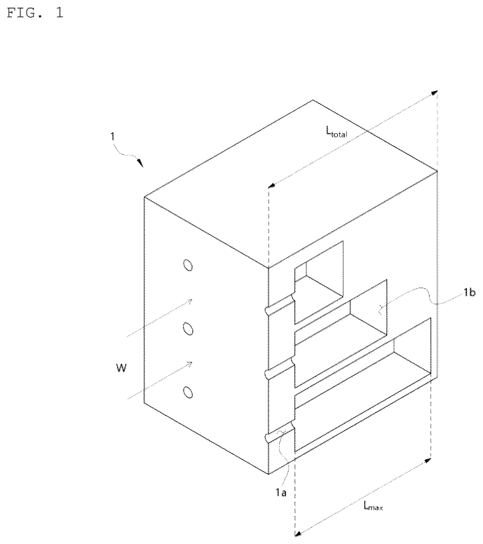

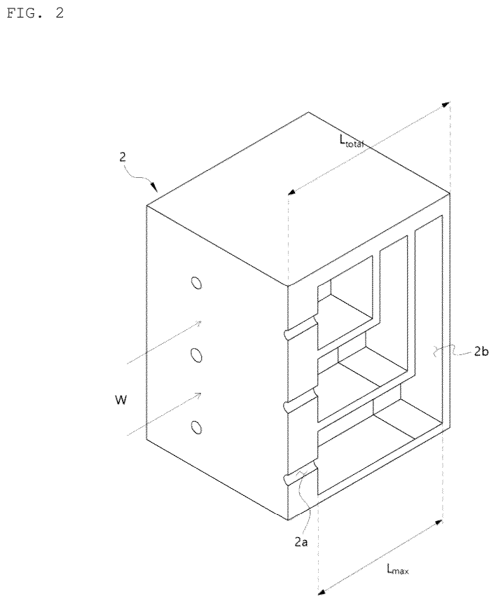

### DETAILED DESCRIPTION OF MAIN ELEMENTS

10: broadband sound absorption device
100: Helmholtz resonator
110: neck portion 120: cavity portion
200: unit sound absorber
210: first unit sound absorber 220: second unit sound absorber
230: third unit sound absorber 240: fourth unit sound absorber

### BEST MODE

Hereinafter, a broadband sound absorption device using area division according to various exemplary embodiments is described in detail with reference to the accompanying drawings. The exemplary embodiments of the present invention to be introduced below are provided by way of example so that the idea of the present invention may be sufficiently transferred to those skilled in the art to which the present invention pertains. Accordingly, the scope of the present invention is not restricted to the following description and accompanying drawings and may be embodied in another form. In addition, throughout the specification, like reference numerals denote like components.

Here, unless indicated otherwise, the terms used in the specification including technical and scientific terms have the same meaning as those that are usually understood by those skilled in the art to which the present invention pertains, and detailed description of the known functions and constitutions that may obscure the gist of the present invention will be omitted.

### First Exemplary Embodiment

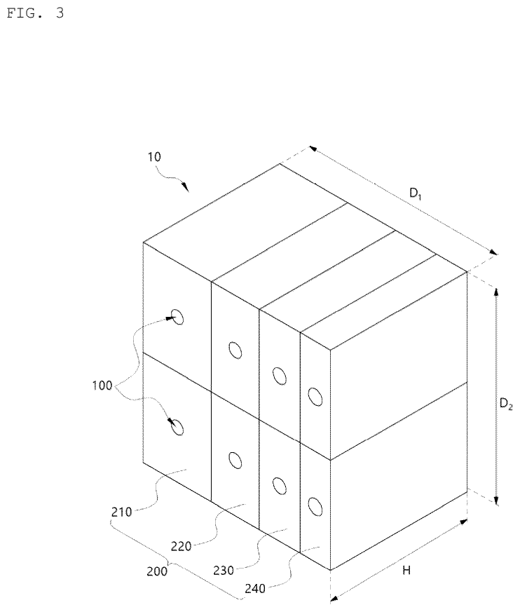

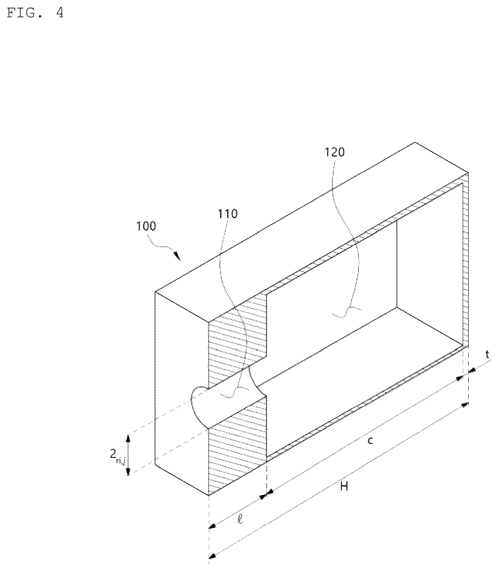

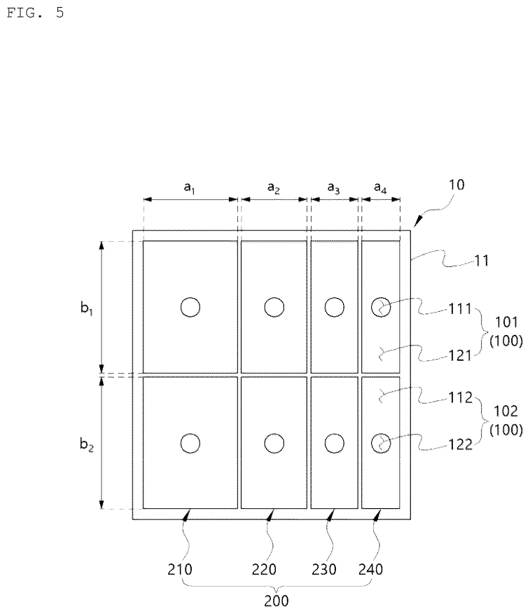

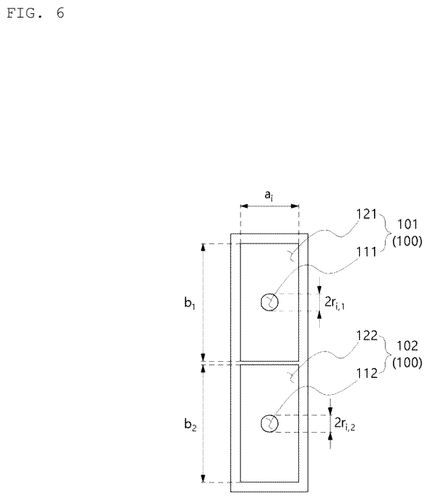

FIGS. 3 to 6 relate to a broadband sound absorption device according to a first exemplary embodiment of the present invention, FIG. 3 is a perspective view of the broadband sound absorption device, FIG. 4 is a cutaway view illustrating a configuration of a Helmholtz resonator, FIG. 5 is a front view of the broadband sound absorption device, and FIG. 6 is a front view of a unit sound absorber.

Referring to FIG. 3, a broadband sound absorption device 10 according to the present invention may include a plurality of unit sound absorbers 200 including at least a pair of Helmholtz resonators 100. Hereinafter, in the description below, for example, in the broadband sound absorption device 10 according to the first exemplary embodiment of the present invention, a unit sound absorber 200 includes a pair of Helmholtz resonators 100 arranged in a vertical direction, and four unit sound absorbers 200 including a first unit sound absorber 210, a second unit sound absorber 220, a third unit sound absorber 230, and a fourth unit sound absorber 240 are arranged in a horizontal direction. In addition, the broadband sound absorption device 10 is assumed to be configured in the shape of a rectangular parallelepiped having a predetermined total horizontal length D₁, total vertical length D₂, and total thickness H. Here, when the broadband sound absorption device 10 has a square cross-section, the total horizontal length D₁ and the total vertical length D₂ may be equal to each other, so the broadband sound absorption device 10 may have the same overall length D. The cross-section of the broadband sound absorption device 10 may be formed in a polygonal or circular shape.

Referring to FIG. 4, the Helmholtz resonator 100 may include a neck portion 110 and a cavity portion 120. Here, the neck portion 110 may be configured in a cylindrical shape having a predetermined neck portion length l and neck portion diameter 2r_{i,j}. In addition, the cavity portion 120 may have a thickness c in a thickness direction, and the cavity portion 120 may be open in the neck portion 110 and sealed by a body having a predetermined thickness t on a rear surface thereof. Accordingly, a total thickness of one of the Helmholtz resonators 100 may be determined through the length of the neck portion l, the thickness of the cavity portion c, and the predetermined thickness t of the body. Here, the plurality of Helmholtz resonators 100 may have the same total thickness, or the shape of the neck portion 110 or the shape of the cavity portion of some of the Helmholtz resonators 100 may be formed as a polygonal pillar or circular pillar. Here, although not separately shown, a cross-sectional area of the cavity portion 120 may be calculated through a width a or length b, and in the description below, it is illustrated as a rectangular cross-section formed by a×b for clearer explanation.

Referring to FIGS. 5 and 6, each of the plurality of Helmholtz resonators 100 constituting the plurality of unit sound absorbers 200 may have a horizontal length a and a vertical length b. Here, any one unit sound absorber 200 may include a first Helmholtz resonator 101 including a first cavity portion 121 having a cross-sectional area of one aᵢ×b₁ and a second Helmholtz resonator 102 including a second cavity portion 122 having a cross-sectional area of aᵢ×b₂. Here, a first neck portion 111 of the first Helmholtz resonator 101 and a second neck portion 122 of the second Helmholtz resonator 102 may be formed to have the same or different length or diameter, and the first Helmholtz resonator 101 and the second Helmholtz resonator 102 may be configured as a pair of subwavelength Helmholtz resonators 100 that resonate in opposite phases at a target frequency to induce hybrid resonance. Here, the pair of subwavelength Helmholtz resonators 100 have the advantage of having a higher sound absorption rate as all reflected wave energy is dissipated in a near-field. Here, the pair of subwavelength Helmholtz resonators 100 may be designed by adjusting the diameter 2r_{i,1} of the first neck portion 111 and the diameter 2r_{i,2} of the second neck portion 121.

The Helmholtz resonator 100 of each of the four unit sound absorbers 200 including the first unit sound absorber 210, the second unit sound absorber 220, the third unit sound absorber 230, and the fourth unit sound absorber 240 may have different horizontal length a or vertical length b to have a different target frequency. The broadband sound absorption device 10 of the first exemplary embodiment of the present invention is described by way of example in which four unit sound absorbers 200 formed to have different horizontal lengths a are arranged in the horizontal direction on a main body 11. Here, the broadband sound absorption device 10 may be designed so that the target frequency increases from the first unit sound absorber 210 toward the fourth unit sound absorber 240, and thus, a horizontal length a₄ of the fourth unit sound absorber 240 may be smaller than a horizontal length a₁ of the first unit sound absorber 210. Accordingly, the broadband sound absorption device 10 according to the present invention has the advantage of achieving a higher sound absorption rate at N frequencies through N unit sound absorbers 200. Here, the N unit sound absorbers 200 may be configured so that a total horizontal length D₁ of the broadband sound absorption device 10 described above is divided into a constant ratio a₁:a₂:a₃:a₄: . . . .

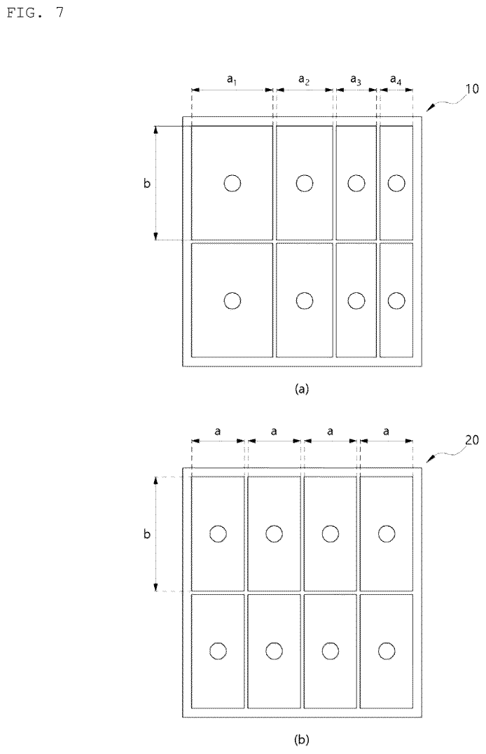

FIG. 7 relates to a broadband sound absorption device according to the first exemplary embodiment of the present invention, and FIG. 7 shows a comparison between the broadband sound absorption device according to the present invention and the sound absorption device of the related art.

Referring to FIG. 7-(a), the broadband sound absorption device 10 including N unit sound absorbers 200 having different target frequencies may be expressed by Equation 2 below.

$${f}_{1} < {f}_{2} < {f}_{3} < {f}_{4} < … < {f}_{N} \qquad [ Equation 2 ]$$

(here, fᵢ: target frequency of i-th unit sound absorber)

Here, the resonance frequency of the Helmholtz resonator is generally inversely proportional to the square root of a cavity volume, so that the volume of the cavity portion 120 of the Helmholtz resonator 100 disposed in each of the plurality of unit sound absorbers may be configured to increase as shown in Equation 3 below.

$${V}_{1} > {V}_{2} > {V}_{3} > {V}_{4} > … > {V}_{N} \qquad [ Equation 3 ]$$

(here, i: cavity portion volume of i-th Helmholtz resonator)

When the cross-sectional area of the Helmholtz resonators is constant as A=a×b, such as the sound absorption device 20 of the related art shown in FIG. 7-(b), the overall thickness H₁ of the device may be determined by Equation 4 below.

$${H}_{1} = \frac{{V}_{1}}{{A}_{1}} = \frac{{V}_{1}}{A / N} = \frac{{NV}_{1}}{A} \qquad [ Equation 4 ]$$

In other words, since the sound absorption device 20 of the related art is determined according to the requirements of the Helmholtz resonator having the lowest target frequency among N unit sound absorbers, a problem in which unnecessary space remains in the Helmholtz resonator having a relatively high target frequency may arise.

In contrast, in the broadband sound absorption device 10 according to the present invention shown in FIG. 7-(a), the total thickness H of the device may be determined by Equation 5 below.

$$H = \frac{V}{A} = \frac{{\sum }_{i}^{N} {V}_{i}}{A} \qquad [ Equation 5 ]$$

$$( here , A = {A}_{1} + {A}_{2} + {A}_{3} + … + {A}_{N} )$$

In other words, the Helmholtz resonator having a low target frequency may be varied to occupy a relatively large area, so that the total thickness H of the device may be maintained to be constant. In this manner, the broadband sound absorption device 10 according to the present invention may lead to the effect of reducing the thickness by the value of H₁−H calculated by Equation 6 below compared to the sound absorption device 20 of the related art.

$${H}_{1} - H = \frac{1}{A} ( {NV}_{1} - {\sum }_{i = 1}^{N} {V}_{i} ) \qquad [ Equation 6 ]$$

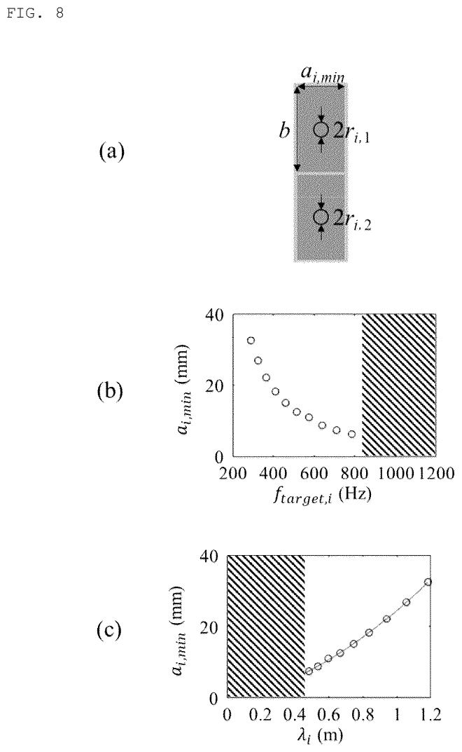

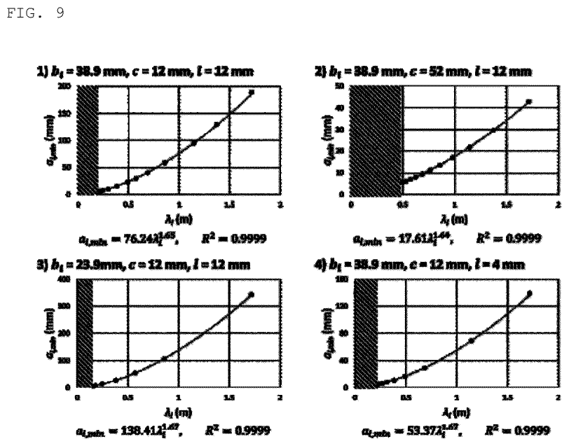

FIGS. 8 and 9 relate to a broadband sound absorption device according to the first exemplary embodiment of the present invention, and FIGS. 8 and 9 are diagrams illustrating a process of calculating a minimum value of a variable component of a cavity portion of a broadband sound absorption device, respectively.

A minimum value of a variable component of the cavity portion 120 of the single unit sound absorber 200 that may achieve perfect sound absorption at a target frequency f_{target,i} given to the single unit sound absorber 200 to derive a relationship between the target frequency of the Helmholtz resonator constituting each unit sound absorber 200 and the variable component may be defined as x_{i,min}. Here, when other components constituting the area of the cavity portion 120 are fixed, a length of the fixed component of the cavity portion area may be fixed to y. Hereinafter, for clarification, the variable component is exemplified as a width and defined as a_{i,min}, and the fixed component is exemplified as a length and defined as b.

In FIG. 8, the geometrical parameters other than the horizontal length of the cavity portion and the radius of the neck are fixed as shown in Table 1 below, and a graph derived by varying the horizontal length is shown.

TABLE 1

| CLASSIFICATION | PARAMETER (UNIT: mm) |
|---|---|
| VERTICAL LENGTH OF | 33.9 |
| CAVITY PORTION(b) | |
| THICKNESS OF | 42 |
| CAVITY PORTION(c) | |
| LENGTH OF NECK(l) | 12 |

Here, there is a structural constraint that the horizontal length of the cavity portion cannot be less than 2r_{i,1} or 2r_{i,2} which is a diameter of the neck portion of a pair of Helmholtz resonators, so a minimum horizontal length in a partial region may be excluded. Here, the excluded values are limited to those in Table 1, and if the variables change, the regions of the excluded values may also change. In other words, design may be made by appropriately adjusting geometrical parameters according to the target frequency. Also, as shown in FIG. 8-c, it can be seen that the minimum horizontal length a_{i,min} of the cavity portion increases as the wavelength λᵢ at the target frequency increases. Here, through a curve fitting method, the minimum horizontal length a_{i,min} of the cavity portion for the wavelength λᵢ may be calculated as shown in Equation 7 below.

$${a}_{i , min} = 21.84 {λ}_{i}^{1.64} , {R}^{2} = 0.9998 \qquad [ Equation 7 ]$$

That is, when the target frequency f_{target,i} is given, the horizontal length of each Helmholtz resonator may be determined through Equation 7, which is the relationship between λᵢ and a_{i,min}.

Referring to FIG. 9, Equation 7 above may be changed as shown in FIGS. 9-(a) to 9-(d) when the shape condition changes. Here, each shape condition in FIG. 9 is shown in Table 2 below.

TABLE 2
unit: (mm)

| CLASSIFICATION | FIG. 9-(a) | FIG. 9-(b) | FIG. 9-(c) | FIG. 9-(d) |
|---|---|---|---|---|
| VERTICAL | 38.9 | 38.9 | 23.9 | 38.9 |
| LENGTH OF | | | | |
| CAVITY | | | | |
| PORTION(b) | | | | |
| THICKNESS OF | 12 | 52 | 12 | 12 |
| THE CAVITY | | | | |
| PORTION(c) | | | | |
| LENGTH OF | 12 | 12 | 12 | 4 |
| NECK(l) | | | | |

In addition, the minimum horizontal length of each cavity portion calculated according to the shape conditions of FIGS. 9-(a) to 9-(d) above may be calculated as shown in Equation 8 below.

$$FIG . 9 - ( a ) : {a}_{i , min} = 76.24 \text{?} , {R}^{2} = 0.9999 \qquad [ Equation 8 ]$$

$$FIG . 9 - ( b ) : {a}_{i , min} = 17.61 \text{?} , {R}^{2} = 0.9999$$

$$FIG . 9 - ( c ) : {a}_{i , min} = 138.41 \text{?} , {R}^{2} = 0.9999$$

$$FIG . 9 - ( d ) : {a}_{i , min} = 53.37 \text{?} , {R}^{2} = 0.9999$$

$$\text{?} \text{indicates text missing or illegible when filed}$$

Here, if the minimum horizontal length a_{i,min} of the cavity portion is expressed as an equation for not only the wavelength λᵢ but also other shape conditions, that is, the vertical length b of the cavity portion, the thickness c of the cavity portion, and the length l of the neck, it may be expressed as shown in Equation 9 below.

$${a}_{i , min} = f ( {λ}_{i} , b , c , l ) = m {λ}_{i}^{n} \qquad [ Equation 9 ]$$

Here, a total horizontal length D₁ and a total vertical length D₂ may be calculated by defining shape conditions by defining and setting a total overall length D to D=2b+3t, the thickness t of the partition between each cavity portion to 1 mm, and a total thickness of the sound absorption device to H=l+c+t.

The constants m and n are functions m=m(b,c,l) and n=n(b,c,l) for, b, c, and l, respectively. Here, various numerical values for b, c, and l may be input to calculate a corresponding combination. If m=m(b,c,l) and n=n(b,c,l) are found therefrom, they may be calculated as shown in Equation 10 and Equation 11 below.

$$m = m ( b , c , l ) = {m}_{1} b + {m}_{2} c + {m}_{3} l + {m}_{4} \qquad [ Equation 10 ]$$

$$n = n ( b , c , l ) = {n}_{1} b + {n}_{2} c + {n}_{3} l + {n}_{4} = {n}_{4} \qquad [ Equation 11 ]$$

(Here, n₁=n₂=n₃=0.)

Through Equation 10 and Equation 11 above, an equation for not only the minimum horizontal length a_{i,min} of the cavity portion, but also the vertical length b of the cavity portion, the thickness c of the cavity portion, and the length l of the neck of other shape conditions may be expressed in more detail as Equation 12 below.

$${a}_{i , min} = m {λ}_{i}^{n} = ( {m}_{1} b + {m}_{2} c + {m}_{3} l + {m}_{4} ) {λ}_{i}^{n} \qquad [ Equation 12 ]$$

Here, the constants, m₁, m₂, m₃, m₄ and n may be formed within the range according to Equation 13 below.

$$- 3 < {m}_{1} < - 1 \qquad [ Equation 13 ]$$

$$- 2 < {m}_{2} < - 1$$

$$- 2 < {m}_{3} < 0$$

$$130 < {m}_{4} < 190$$

$$1.6 < n < 1.7$$

Also, the sum

$${\sum }_{i}^{N} {a}_{i}$$

of the total length D and the components of the horizontal lengths of the Helmholtz resonators of each of the arranged unit sound absorbers may be formed by Equation 14 below.

$${\sum }_{i}^{N} {a}_{i} = D - ( N + 1 ) t \qquad [ Equation 14 ]$$

(Here, N=total number of arranged Helmholtz resonators, t: partition thickness of unit sound absorber)

Here, the partition thickness of the unit sound absorber may be selected by considering a minimum thickness that may be manufactured, and N unit sound absorbers may be arranged to be divided at a certain ratio with respect to the total area by satisfying Equation 14 above and at the same time adjusting the horizontal length aᵢ of each unit sound absorber cavity to be proportional to a_{i,min} obtained for the target frequency f_{target,i}. In the above description, the horizontal direction is used as an example for clarification, but this may be changed to the vertical direction or may be designed considering both the horizontal and vertical directions.

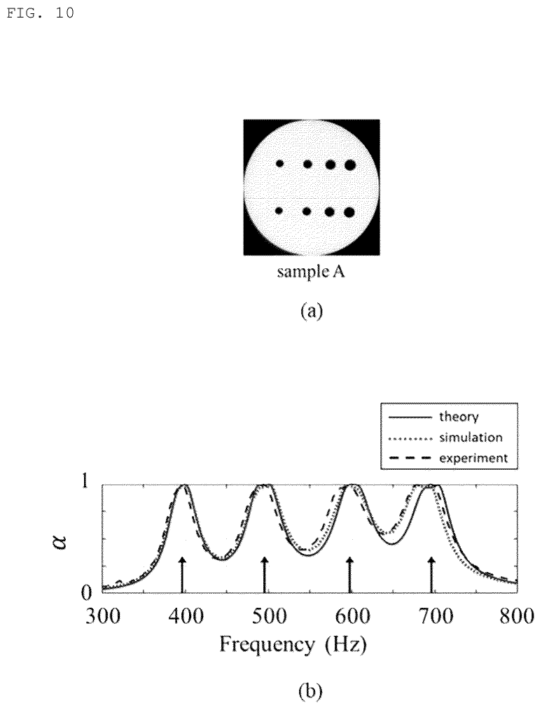

FIGS. 10 to 12 relate to a broadband sound absorption device according to the first exemplary embodiment of the present invention, and FIGS. 10 to 12 each show diagrams illustrating sound absorption performance based on a combination of various target frequencies.

As described above, the broadband sound absorption device according to the present invention has a structure in which a plurality of unit sound absorbers are arranged to divide the area according to the target frequency and may achieve perfect sound absorption at a plurality of frequencies simultaneously. Also, by appropriately selecting the number of unit cells and the target frequency intervals between each unit cell, a sound absorption device that exhibits a broadband high sound absorption may be designed. Hereinafter, in FIGS. 10 to 12, sound absorption spectrum results that may be achieved through the present invention may be calculated in more detail by confirming the performance according to different target frequency combination. Here, FIGS. 10 to 12 show sound absorption spectra calculated through three different target frequency combinations using four unit sound absorbers.

Referring to FIG. 10, FIG. 10-(a) shows the sound absorption spectra of four unit sound absorbers whose shape conditions are determined as shown in Table 3 below. Here, other geometrical parameters except the horizontal length of the cavity portion and the radius of the neck portion are determined as shown in Table 1 above.

TABLE 3

| | FIRST | | SECOND | | THIRD | | FOURTH | |
|---|---|---|---|---|---|---|---|---|
| | UNIT | | UNIT | | UNIT | | UNIT | |
| | SOUND | | SOUND | | SOUND | | SOUND | |
| CLASSIFICATION | ABSORBER | | ABSORBER | | ABSORBER | | ABSORBER | |
| TARGET | 400 | Hz | 500 | Hz | 600 | Hz | 700 | Hz |
| FREQUENCY | | | | | | | | |
| (f_{target, i}) | | | | | | | | |
| HORIZONTAL | 21.6 | mm | 17.3 | mm | 14.4 | mm | 12.40 | mm |
| LENGTH (aᵢ) | | | | | | | | |
| RADIUS OF | 2.92 | mm | 3.31 | mm | 3.77 | mm | 4.14 | mm |
| FIRST NECK | | | | | | | | |
| PORTION (r_{i, 1}) | | | | | | | | |
| RADIUS OF | 3.02 | mm | 3.45 | mm | 3.91 | mm | 4.30 | mm |
| SECOND NECK | | | | | | | | |
| PORTION (r_{i, 2}) | | | | | | | | |

Here, the radius r_{i,1} of the first neck portion and the radius r_{i,2} of the second neck portion relate to the radius of the neck portion of each of a pair of Helmholtz resonators included in a single unit sound absorber, and the pair of Helmholtz resonators may be designed to be subwavelength to each other.

As shown in FIG. 10-(b), the device combined in FIG. 10-(a) is experimentally shown to have achieved perfect sound absorption at the target frequency, the results thereof are consistent with the sound absorption performance predicted by theory and simulation.

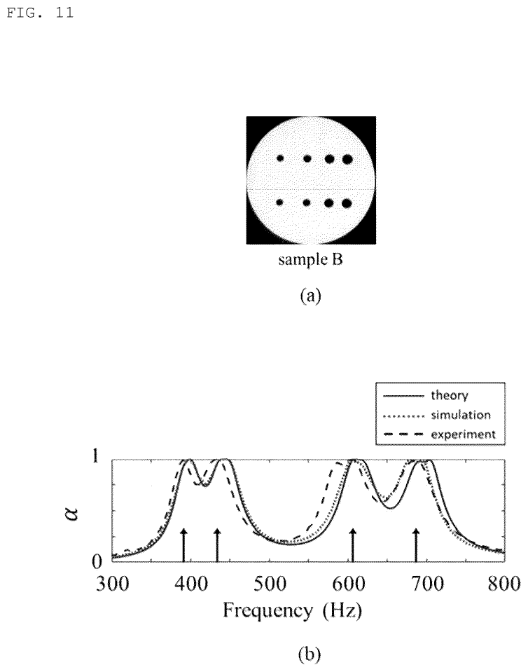

Referring to FIG. 11, FIG. 11-(a) shows the sound absorption spectra of four unit sound absorbers whose shape conditions are determined as shown in Table 4 below. Here, other geometrical parameters except the horizontal length of the cavity portion and the radius of the neck portion are determined as shown in Table 1 above.

TABLE 4

| | FIRST | | SECOND | | THIRD | | FOURTH | |
|---|---|---|---|---|---|---|---|---|
| | UNIT | | UNIT | | UNIT | | UNIT | |
| | SOUND | | SOUND | | SOUND | | SOUND | |
| CLASSIFICATION | ABSORBER | | ABSORBER | | ABSORBER | | ABSORBER | |
| TARGET | 400 | Hz | 440 | Hz | 610 | Hz | 700 | Hz |
| FREQUENCY | | | | | | | | |
| (f_{target, i}) | | | | | | | | |
| HORIZONTAL | 21.6 | mm | 19.0 | mm | 13.7 | mm | 12.0 | mm |
| LENGTH (aᵢ) | | | | | | | | |
| RADIUS OF | 2.88 | mm | 3.10 | mm | 3.75 | mm | 4.07 | mm |
| FIRST NECK | | | | | | | | |
| PORTION (r_{i, 1}) | | | | | | | | |
| RADIUS OF | 2.95 | mm | 3.21 | mm | 3.88 | mm | 4.22 | mm |
| SECOND NECK | | | | | | | | |
| PORTION (r_{i, 2}) | | | | | | | | |

As shown in FIG. 11-(b), the device combined with FIG. 11-(a) matches the sound absorption performance of the sound absorption device obtained through theory, simulations, and experiments, and perfect sound absorption is achieved at the target frequency.

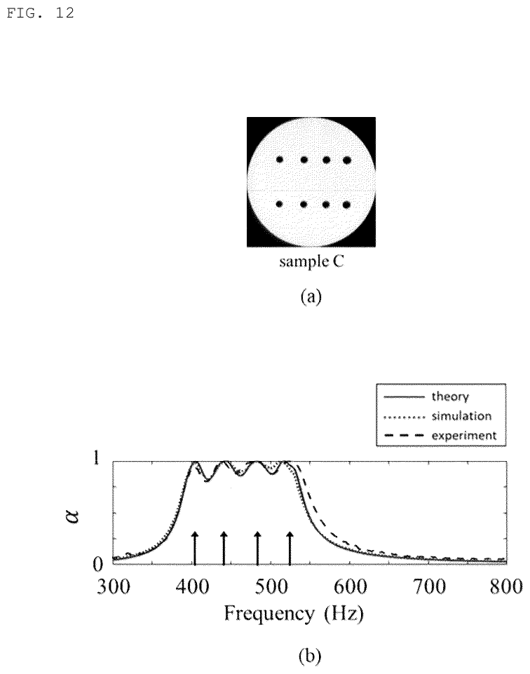

Referring to FIG. 12, FIG. 12-(a) shows the sound absorption spectra of four unit sound absorbers whose shape conditions are determined as shown in Table 5 below. Here, other geometrical parameters except the horizontal length of the cavity portion and the radius of the neck portion are determined as shown in Table 1 above.

TABLE 5

| | FIRST | | SECOND | | THIRD | | FOURTH | |
|---|---|---|---|---|---|---|---|---|
| | UNIT | | UNIT | | UNIT | | UNIT | |
| | SOUND | | SOUND | | SOUND | | SOUND | |
| CLASSIFICATION | ABSORBER | | ABSORBER | | ABSORBER | | ABSORBER | |
| TARGET | 400 | Hz | 440 | Hz | 485 | Hz | 525 | Hz |
| FREQUENCY | | | | | | | | |
| (f_{target, i}) | | | | | | | | |
| HORIZONTAL | 18.8 | mm | 17.1 | mm | 15.5 | mm | 14.30 | mm |
| LENGTH (aᵢ) | | | | | | | | |
| RADIUS OF | 2.76 | mm | 2.90 | mm | 3.07 | mm | 3.23 | mm |
| FIRST NECK | | | | | | | | |
| PORTION (r_{i, 1}) | | | | | | | | |
| RADIUS OF | 2.81 | mm | 2.97 | mm | 3.15 | mm | 3.32 | mm |
| SECOND NECK | | | | | | | | |
| PORTION (r_{i, 2}) | | | | | | | | |

As shown in FIG. 12-(b), the device combined with FIG. 12-(a) matches well the sound absorption performance of the sound absorption device obtained through theory, simulations, and experiments, and perfect sound absorption is achieved at the target frequency. In particular, a sound absorption rate of 80% or more is achieved in the frequency range (with Δf/f_{c}=0.32 based on a center frequency f_{c}=468 Hz) of about 150 Hz between 394 Hz and 543 Hz, thereby advantageously having a wider band.

### Second Exemplary Embodiment

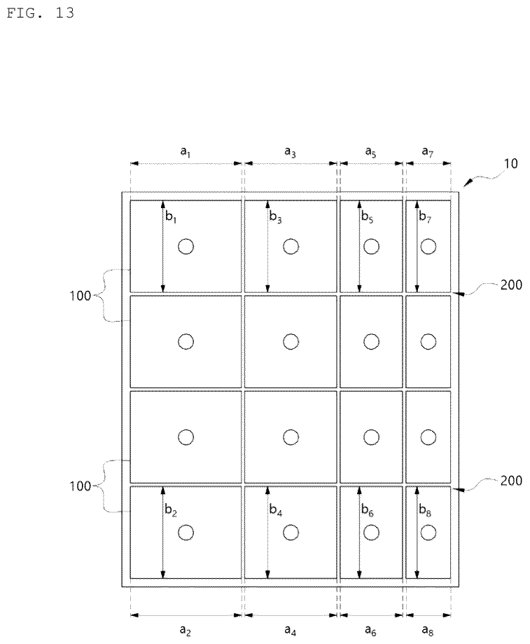

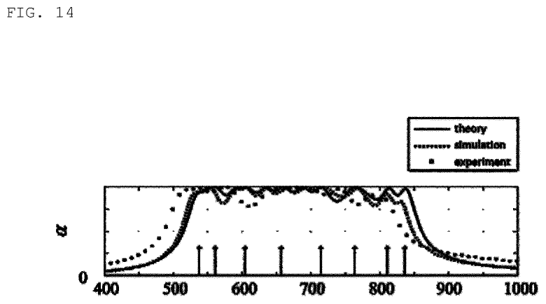

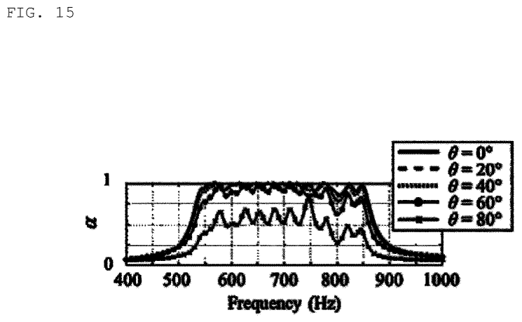

FIGS. 13 to 15 relate to a broadband sound absorption device according to a second exemplary embodiment of the present invention. FIG. 13 is a front view of the broadband sound absorption device, FIG. 14 is a diagram illustrating sound absorption performance based on a combination of target frequencies, and FIG. 15 shows a diagram illustrating the sound absorption performance based on an angle of incidence of sound.

Referring to FIG. 13, the broadband sound absorption device according to the second exemplary embodiment of the present invention includes at least a pair of Helmholtz resonators 100 arranged in the vertical direction and a plurality of unit sound absorbers 200 arranged in the horizontal direction, and here, since the plurality of unit sound absorbers 200 are formed also in the vertical direction, a two-dimensional arrangement may be formed. Here, the unit sound absorber 200 includes a pair of Helmholtz resonators 100 having a subwavelength scale, and each Helmholtz resonator may have a cavity portion including a predetermined horizontal length aᵢ and a vertical length bᵢ. Here, the shape of the neck portion 110 or the shape of the cavity portion of some Helmholtz resonators 100 may be changed to a polygonal or circular shape, etc. Some of the plurality of unit sound absorbers 200 arranged in the horizontal direction may each include Helmholtz resonators having different horizontal lengths aᵢ, and some of the plurality of unit sound absorbers 200 arranged in the vertical direction may also include Helmholtz resonators having different horizontal lengths aᵢ. Alternatively, a plurality of unit sound absorbers 200 arranged at the same vertical position may have the same vertical length bᵢ. Hereinafter, for clarification, eight unit sound absorbers 200 arranged in a 4×2 matrix structure are described as an example.

Referring to FIG. 14, the sound absorption spectra of eight unit sound absorbers whose shape conditions are determined as shown in Table 6 below are shown. Here, other geometrical parameters except the horizontal and vertical lengths of the cavity portion and the radius of the neck portion are determined as shown in Table 1 above.

TABLE 6

| | | | | RADIUS | RADIUS |
|---|---|---|---|---|---|
| | | | | OF FIRST | OF SECOND |
| | TARGET | HORIZONTAL | VERTICAL | NECK | NECK |
| | FREQUENCY | LENGTH | LENGTH | PORTION | PORTION |
| CLASSIFICATION | (f_{target, i}) | (aᵢ) | (bᵢ) | (r_{i, 1}) | (r_{i, 2}) |
| FIRST | 540 Hz | 20.3 mm | 17.0 mm | 2.77 mm | 2.79 mm |
| UNIT SOUND | | | | | |
| ABSORBER | | | | | |
| SECOND | 560 Hz | | 16.4 mm | 2.83 mm | 2.90 mm |
| UNIT SOUND | | | | | |
| ABSORBER | | | | | |
| THIRD | 605 Hz | 17.7 mm | 17.4 mm | 2.96 mm | 3.06 mm |
| UNIT SOUND | | | | | |
| ABSORBER | | | | | |
| FOURTH | 660 Hz | | 16.0 mm | 3.09 mm | 3.24 mm |
| UNIT SOUND | | | | | |
| ABSORBER | | | | | |
| FIFTH | 715 Hz | 15.1 mm | 17.2 mm | 3.27 mm | 3.44 mm |
| UNIT SOUND | | | | | |
| ABSORBER | | | | | |
| SIXTH | 765 Hz | | 16.1 mm | 3.57 mm | 3.75 mm |
| UNIT SOUND | | | | | |
| ABSORBER | | | | | |
| SEVENTH | 812 Hz | 13.6 mm | 16.9 mm | 3.63 mm | 3.82 mm |
| UNIT SOUND | | | | | |
| ABSORBER | | | | | |
| EIGHTH | 836 Hz | | 16.4 mm | 3.92 mm | 3.94 mm |
| UNIT SOUND | | | | | |
| ABSORBER | | | | | |

Here, as described in Table 6 above, unit sound absorbers arranged in the vertical direction may be formed to have the same horizontal length. In addition, as shown in FIG. 14, the device according to Table 6 above perfectly absorbs sound at multiple frequencies, and the sound absorption device having a thickness of about 1/11 compared to the wavelength is verified to achieve a high sound absorption rate of 83% or more in a wide frequency range (with Δf/f_{c}=0.47 based on a center frequency f_{c}=659 Hz) from 503 Hz to 815 Hz.

Referring to FIG. 15, it appears that the device designed as shown in Table 6 above may absorb acoustic energy with a high sound absorption rate not only when it is incident perpendicularly, but also when it is incident at an inclined angle. Here, the sound absorption performance of the broadband sound absorption device according to the present invention according to the angle of incidence may be calculated by Equation 15 below.

$$α ( θ ) = \frac{4 Re ( ζ ) cos θ}{{( \vert ζ \vert cos θ )}^{2} + 2 Re ( ζ ) cos ( θ ) + 1} \qquad [ Equation 15 ]$$

It can be seen that the broadband sound absorption device of the present invention according to FIG. 15 and Equation 15 maintains performance above 85% in a wider frequency band and maintains sound absorption performance at the angle of incidence from 0° to 60°. This may lead to advantages that may be utilized in various environments.

### Third Exemplary Embodiment

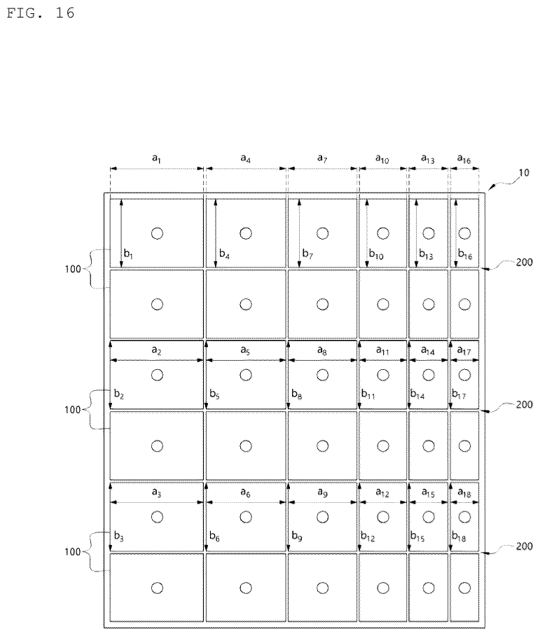

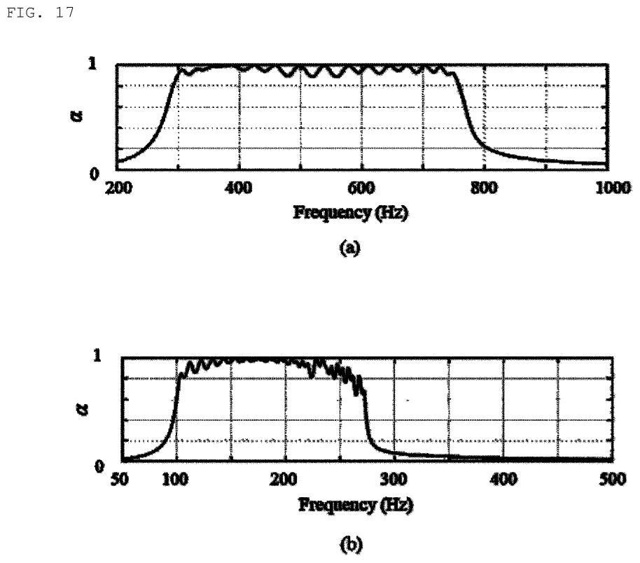

FIGS. 16 and 17 relate to a broadband sound absorption device according to a third exemplary embodiment of the present invention. FIG. 16 shows a front view of the broadband sound absorption device, and FIG. 17 shows a diagram illustrating sound absorption performance based on a combination of target frequencies.

Referring to FIG. 16, the broadband sound absorption device according to the third exemplary embodiment of the present invention has a structure in which more unit sound absorbers are arranged to divide the area according to the target frequency, and may achieve perfect sound absorption at broadband frequencies simultaneously. As an example, 18 unit sound absorbers 200 including a pair of subwavelength Helmholtz resonators 100 may be arranged, and as the 18 unit sound absorbers 200 have different target frequencies, they may be provided to perfectly absorb sound at a broadband frequency.

TABLE 7

| CLASSIFICATION | PARAMETER (UNIT: mm) |
|---|---|
| AREA OF DEVICE | 120 × 120 |
| THICKNESS OF THE | 98 |
| CAVITY PORTION(c) | |
| LENGTH OF NECK(l) | 1 |

Referring to FIG. 17-(a), the sound absorption spectra of 18 unit sound absorbers whose shape conditions are determined as shown in Table 8 below are shown. Here, other geometrical parameters excluding the horizontal and vertical lengths of the cavity portion and the radius of the neck portion are determined as shown in Table 7 above.

TABLE 8

| | | | | | RADIUS | RADIUS |
|---|---|---|---|---|---|---|
| | | | | | OF FIRST | OF SECOND |
| | TARGET | HORIZONTAL | | VERTICAL | NECK | NECK |
| | FREQUENCY | LENGTH | | LENGTH | PORTION | PORTION |
| CLASSIFICATION | (f_{target, i}) | (aᵢ) | | (bᵢ) | (r_{i, 1}) | (r_{i, 2}) |
| FIRST | 290 Hz | 37.2 | mm | 20.4 mm | 1.40 mm | 1.41 mm |
| UNIT SOUND | | | | | | |
| ABSORBER | | | | | | |
| SECOND | 300 Hz | | | 19.3 mm | 1.43 mm | 1.44 mm |
| UNIT SOUND | | | | | | |
| ABSORBER | | | | | | |
| THIRD | 325 Hz | | | 16.8 mm | 1.47 mm | 1.48 mm |
| UNIT SOUND | | | | | | |
| ABSORBER | | | | | | |
| FOURTH | 345 Hz | 27.4 | mm | 20.6 mm | 1.51 mm | 1.52 mm |
| UNIT SOUND | | | | | | |
| ABSORBER | | | | | | |
| FIFTH | 360 Hz | | | 19.2 mm | 1.55 mm | 1.56 mm |
| UNIT SOUND | | | | | | |
| ABSORBER | | | | | | |
| SIXTH | 390 Hz | | | 16.7 mm | 1.58 mm | 1.59 mm |
| UNIT SOUND | | | | | | |
| ABSORBER | | | | | | |
| SEVENTH | 425 Hz | 18.5 | mm | 21.5 mm | 1.64 mm | 1.65 mm |
| UNIT SOUND | | | | | | |
| ABSORBER | | | | | | |
| EIGHTH | 460 Hz | | | 18.8 mm | 1.72 mm | 1.73 mm |
| UNIT SOUND | | | | | | |
| ABSORBER | | | | | | |
| NINTH | 500 Hz | | | 16.3 mm | 1.81 mm | 1.82 mm |
| UNIT SOUND | | | | | | |
| ABSORBER | | | | | | |
| TENTH | 540 Hz | 12.5 | mm | 21.0 mm | 1.91 mm | 1.92 mm |
| UNIT SOUND | | | | | | |
| ABSORBER | | | | | | |
| ELEVENTH | 580 Hz | | | 18.6 mm | 2.03 mm | 2.04 mm |
| UNIT SOUND | | | | | | |
| ABSORBER | | | | | | |
| TWELFTH | 615 Hz | | | 16.9 mm | 2.19 mm | 2.20 mm |
| UNIT SOUND | | | | | | |
| ABSORBER | | | | | | |
| THIRTEENTH | 650 Hz | 9.5 | mm | 20.3 mm | 2.36 mm | 2.37 mm |
| UNIT SOUND | | | | | | |
| ABSORBER | | | | | | |
| FOURTEENTH | 680 Hz | | | 18.8 mm | 2.55 mm | 2.56 mm |
| UNIT SOUND | | | | | | |
| ABSORBER | | | | | | |
| FIFTEENTH | 710 Hz | | | 17.4 mm | 2.76 mm | 2.77 mm |
| UNIT SOUND | | | | | | |
| ABSORBER | | | | | | |
| SIXTEENTH | 735 Hz | 8.0 | mm | 19.6 mm | 3.04 mm | 3.05 mm |
| UNIT SOUND | | | | | | |
| ABSORBER | | | | | | |
| SEVENTEENTH | 755 Hz | | | 18.7 mm | 3.34 mm | 3.35 mm |
| UNIT SOUND | | | | | | |
| ABSORBER | | | | | | |
| EIGHTEENTH | 765 Hz | | | 18.3 mm | 3.64 mm | 3.65 mm |
| UNIT SOUND | | | | | | |
| ABSORBER | | | | | | |

Here, as described in Table 8 above, unit sound absorbers arranged in the vertical direction may be formed to have the same horizontal length. In addition, as shown in FIG. 17-(a), the device according to Table 8 above may perfectly absorb sound at multiple frequencies, and the sound absorption device having a thickness of about 1/12 compared with the reference wavelength for the lowest target frequency is verified to achieve a high sound absorption rate of 80% or more in the mid-to-low frequency broadband frequency range (with Δf/f_{c}=0.89 based on a center frequency f_{c}=525 Hz) from 292 Hz to 758 Hz.

TABLE 9

| CLASSIFICATION | PARAMETER (UNIT: mm) |
|---|---|
| AREA OF DEVICE | 280 × 280 |
| THICKNESS OF THE | 298 |
| CAVITY PORTION(c) | |
| LENGTH OF NECK(l) | 1 |

Referring to FIG. 17-(b), the sound absorption spectra of 18 unit sound absorbers whose shape conditions are determined as shown in Table 10 below to absorb sound in a low frequency band of 300 Hz or less are shown. Here, other geometrical parameters except the horizontal length and vertical length of the cavity portion and the radius of the neck portion are determined as shown in Table 9 above.

TABLE 10

| | | | | | RADIUS | RADIUS |
|---|---|---|---|---|---|---|
| | | | | | OF FIRST | OF SECOND |
| | TARGET | HORIZONTAL | | VERTICAL | NECK | NECK |
| | FREQUENCY | LENGTH | | LENGTH | PORTION | PORTION |
| CLASSIFICATION | (f_{target, i}) | (aᵢ) | | (bᵢ) | (r_{i, 1}) | (r_{i, 2}) |
| FIRST | 102 Hz | 37.2 | mm | 20.4 mm | 1.40 mm | 1.41 mm |
| UNIT SOUND | | | | | | |
| ABSORBER | | | | | | |
| SECOND | 110 Hz | | | 19.3 mm | 1.43 mm | 1.44 mm |
| UNIT SOUND | | | | | | |
| ABSORBER | | | | | | |
| THIRD | 120 Hz | | | 16.8 mm | 1.47 mm | 1.48 mm |
| UNIT SOUND | | | | | | |
| ABSORBER | | | | | | |
| FOURTH | 130 Hz | 27.4 | mm | 20.6 mm | 1.51 mm | 1.52 mm |
| UNIT SOUND | | | | | | |
| ABSORBER | | | | | | |
| FIFTH | 140 Hz | | | 19.2 mm | 1.55 mm | 1.56 mm |
| UNIT SOUND | | | | | | |
| ABSORBER | | | | | | |
| SIXTH | 150 Hz | | | 16.7 mm | 1.58 mm | 1.59 mm |
| UNIT SOUND | | | | | | |
| ABSORBER | | | | | | |
| SEVENTH | 160 Hz | 18.5 | mm | 21.5 mm | 1.64 mm | 1.65 mm |
| UNIT SOUND | | | | | | |
| ABSORBER | | | | | | |
| EIGHTH | 170 Hz | | | 18.8 mm | 1.72 mm | 1.73 mm |
| UNIT SOUND | | | | | | |
| ABSORBER | | | | | | |
| NINTH | 180 Hz | | | 16.3 mm | 1.81 mm | 1.82 mm |
| UNIT SOUND | | | | | | |
| ABSORBER | | | | | | |
| TENTH | 190 Hz | 12.5 | mm | 21.0 mm | 1.91 mm | 1.92 mm |
| UNIT SOUND | | | | | | |
| ABSORBER | | | | | | |
| ELEVENTH | 200 Hz | | | 18.6 mm | 2.03 mm | 2.04 mm |
| UNIT SOUND | | | | | | |
| ABSORBER | | | | | | |
| TWELFTH | 210 Hz | | | 16.9 mm | 2.19 mm | 2.20 mm |
| UNIT SOUND | | | | | | |
| ABSORBER | | | | | | |
| THIRTEENTH | 220 Hz | 9.5 | mm | 20.3 mm | 2.36 mm | 2.37 mm |
| UNIT SOUND | | | | | | |
| ABSORBER | | | | | | |
| FOURTEENTH | 225 Hz | | | 18.8 mm | 2.55 mm | 2.56 mm |
| UNIT SOUND | | | | | | |
| ABSORBER | | | | | | |
| FIFTEENTH | 230 Hz | | | 17.4 mm | 2.76 mm | 2.77 mm |
| UNIT SOUND | | | | | | |
| ABSORBER | | | | | | |
| SIXTEENTH | 240 Hz | 8.0 | mm | 19.6 mm | 3.04 mm | 3.05 mm |
| UNIT SOUND | | | | | | |
| ABSORBER | | | | | | |
| SEVENTEENTH | 245 Hz | | | 18.7 mm | 3.34 mm | 3.35 mm |
| UNIT SOUND | | | | | | |
| ABSORBER | | | | | | |
| EIGHTEENTH | 250 Hz | | | 18.3 mm | 3.64 mm | 3.65 mm |
| UNIT SOUND | | | | | | |
| ABSORBER | | | | | | |

Here, as described in Table 10 above, unit sound absorbers arranged in the vertical direction may be formed to have the same horizontal length. In addition, as shown in FIG. 17-(b), the device according to Table 10 above may perfectly absorb sound in the low frequency band, and the sound absorption device having a thickness of about 1/11 compared to the lowest target frequency reference wavelength is verified to achieve a high sound absorption rate of 80% or more in the mid-to-low frequency broadband frequency range (with Δf/f_{c}=0.84 based on a center frequency f_{c}=178 Hz) from 103 Hz to 253 Hz.

Next, in order to more clearly verify the sound absorption performance of the broadband sound absorption device according to the present invention, the Figure of Merit (FOM) defined by Equation 16 below may be used.

$$FOM = [ {α}_{90 avg} ] \times [ \frac{Δ {f}_{90}}{{f}_{90 c}} ] \times [ \frac{{λ}_{90 max}}{\sqrt[3]{V}} ] \qquad [ Equation 16 ]$$

(Here,
α_{90avg}: an average sound absorption rate in a sound absorption rate band of 90% or more,
Δf₉₀: a width of a sound absorption rate band of 90% or more,
f_{90c}: a center frequency of a sound absorption rate band of 90% or more,
λ₉₀ₘₐₓ: the longest wavelength in a sound absorption rate band of 90% or more, and
V: a volume of the cavity portion)

The performance index defined in Equation 16 above may be a measure of how high the sound absorption performance α_{90avg} is achieved in a wide frequency band

$$\frac{Δ {f}_{90}}{{f}_{90 c}}$$

with how thin the structure

$$\frac{{λ}_{90 max}}{\sqrt[3]{V}}$$

is. Here, when the structure representing the spectra of FIG. 17-(a) and FIG. 17-(b) is calculated through FOM, the values are calculated as 8.32 and 5.84, respectively, resulting in improved performance. Here, the broadband sound absorption device according to the present invention may be formed to have a FOM of various values, and more preferably, may be formed to have a FOM of 3 or more. In addition, the values of the aforementioned variables are fixed for more clarity, and the present invention is not limited to the aforementioned values, and the values of the variables may be appropriately designed according to a desired frequency band, etc.

### Fourth Exemplary Embodiment

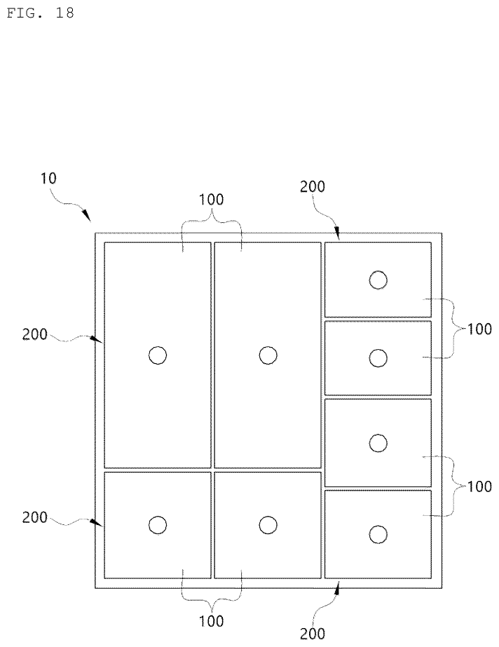

FIG. 18 relates to a broadband sound absorption device according to a fourth exemplary embodiment of the present invention, and FIG. 18 shows a front view of the broadband sound absorption device.

Referring to FIG. 18, in the broadband sound absorption device 10 according to the fourth exemplary embodiment of the present invention, a plurality of unit sound absorbers 200 including the Helmholtz resonators 100 arranged in the horizontal direction may be arranged in the horizontal direction, or a plurality of unit sound absorbers 200 including the Helmholtz resonators 100 arranged in the vertical direction may be arranged in the vertical direction. Alternatively, by adjusting the arrangement direction of the Helmholtz resonator 100 of each unit sound absorber 200 and the arrangement direction of the plurality of unit sound absorbers 200, the broadband sound absorption device 10 may be configured so that the plurality of unit sound absorbers 200 form a rectangular sound-absorbing surface. Furthermore, the plurality of unit sound absorbers 200 may form a polygonal or circular sound-absorbing surface.

Hereinabove, although the present invention has been described by specific matters, such as detailed components, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

### INDUSTRIAL APPLICABILITY

According to the present invention, the broadband sound absorption device using area division capable of adjusting a resonance frequency of each Helmholtz resonator by changing any one of components constituting an area of a cavity portion may be provided. Through this, multiple pieces of frequency noise may be selectively absorbed or broadband noise may be absorbed with a thickness smaller than the related art, thereby solving the problem of noise required in the field of large home appliances, such as clothes dryers and dishwashers, and power generation and electricity fields, such as transformers, as the fields that require selective absorption of multiple pieces of frequency noise, and also a field of transportation means, such as vehicles and drones, urban air mobility (UAM), and a mobile device field, such as smartphones and tablets, as fields that require broadband noise absorption.

1. A broadband sound absorption device comprising:
a Helmholtz resonator including a neck portion and a cavity portion connected to the neck portion and having a predetermined area and thickness; and
a unit sound absorber including at least a pair of the Helmholtz resonators,
wherein the unit sound absorbers are provided in plurality and arranged on a plane or curved surface, and
the plurality of unit sound absorbers include Helmholtz resonators having cavity portions with different areas, respectively.

2. The broadband sound absorption device of claim 1, wherein the unit sound absorber includes at least a pair of Helmholtz resonators that satisfies an equation below
f₁≤f_{T}≤f₂
(wherein:
f₁: a resonance frequency of one Helmholtz resonator,
f₂: a resonance frequency of another Helmholtz resonator, and
f_{T}: a target frequency).

3. The broadband sound absorption device of claim 2, wherein, in the Helmholtz resonator of each of the plurality of unit sound absorbers, any one of a width and a length forming the area of the cavity portion is different to have a different target frequency.

4. The broadband sound absorption device of claim 2, wherein, in the Helmholtz resonator of each of the plurality of unit sound absorbers, a cross-section of the cavity portion is polygonal or circular.

5. The broadband sound absorption device of claim 3, wherein
some of the plurality of unit sound absorbers each includes Helmholtz resonators having the same horizontal length and different vertical lengths, and
some of the unit sound absorbers are arranged in a vertical direction.

6. The broadband sound absorption device of claim 3, wherein
some of the plurality of unit sound absorbers each includes Helmholtz resonators having different horizontal lengths and the same vertical length, and
some of the unit sound absorbers are arranged in a horizontal direction.

7. The broadband sound absorption device of claim 5, wherein a plurality of the unit sound absorbers form a polygonal or circular sound absorbing surface.

8. The broadband sound absorption device of claim 7, wherein the others of the plurality of unit sound absorbers have an arrangement in a different direction from some of the unit sound absorbers.

9. The broadband sound absorption device of claim 3, wherein,
in the Helmholtz resonator of each of the plurality of unit sound absorbers,
a minimum value x_{i,min} of a variable component forming the area of the cavity portion is calculated by an equation below
x_{i,min}=f(λᵢ,y,c,l)=mλᵢⁿ
(wherein
$$A = x \times y ,$$
λᵢ: a target wavelength,
A: an area of the cavity portion,
y: a length of a fixed component of area of cavity portion,
c: a thickness of the cavity portion,
l: a length of the neck portion, and
m, n=constant).

10. The broadband sound absorption device of claim 9, wherein,
in the Helmholtz resonator of each of the plurality of unit sound absorbers,
the minimum value x_{i,min} of the variable component forming the area of the cavity portion is calculated by an equation below
$${x}_{i , min} = m {λ}_{i}^{n} = ( {m}_{1} y + {m}_{2} c + {m}_{3} l + {m}_{4} ) {λ}_{i}^{n}$$
(wherein m₁, m₂, m₃, m₄=constant).

11. The broadband sound absorption device of claim 10, wherein the constants m₁, m₂, m₃, m₄ and n are formed within the range below
−3<m₁<−1
−2<m₂<−1
−2<m₃<0
130<m₄<190
1.6<n<1.7.

12. The broadband sound absorption device of claim 9, wherein
a total length (D) in a direction of a variable component and a sum
$$( {\sum }_{i}^{N} {x}_{i} )$$
of variable components of the Helmholtz resonators of each of the unit sound absorbers arranged are formed by a relational expression below
$${\sum }_{i}^{N} {x}_{i} = D - ( N + 1 ) t$$
(wherein
N=a total number of disposed Helmholtz resonators, and
t: a thickness of a partition of unit sound absorber).

13. The broadband sound absorption device of claim 1, wherein,
in the plurality of unit sound absorbers, a predetermined frequency band having a sound absorption rate of 90% or more forms a sound absorption rate band, and FOM calculated by an equation below is 3 or more
$$FOM = [ {α}_{90 avg} ] \times [ \frac{Δ {f}_{90}}{{f}_{90 c}} ] \times [ \frac{{λ}_{90 max}}{\sqrt[3]{V}} ]$$
(wherein
α_{90avg}: an average sound absorption rate in a sound absorption rate band of 90% or more,
Δf₉₀: a width of a sound absorption rate band of 90% or more,
f_{90c}: a center frequency of the sound absorption rate band of 90% or more,
λ₉₀ₘₐₓ: a longest wavelength in the sound absorption rate band of 90% or more, and
V: a volume of cavity portion).
